(19) United States
(12) Patent Application Publication
(10) Pub. No.: US 2016/0111844 A1
(43) Pub. Date: Apr. 21, 2016

(54) OPTICAL MODULE

(71) Applicant: PlayNitride Inc., Tainan City (TW)

(72) Inventors: Sheng-Yuan Sun, Tainan City (TW); Kuan-Yung Liao, Tainan City (TW); Po-Jen Su, Tainan City (TW); Gwo-Jiun Sheu, Tainan City (TW)

(21) Appl. No.: 14/856,559

(22) Filed: Sep. 17, 2015

(30) Foreign Application Priority Data
Oct. 20, 2014 (TW) 103136133

(51) Int. Cl. H01S 3/00; G02B 5/02

(52) U.S. Cl. CPC H01S 3/005; G02B 5/02

(57) ABSTRACT

An optical module includes a first light source, a second light source and a wavelength conversion member. The first light source and the second light source emit light with different colors. The first light source and the second light source have a first light axis and a second light axis, respectively, and there is an intersection point of the first light axis and the second light axis. The wavelength conversion member is disposed at the intersection point of the first light axis and the second light axis.

### CROSS-REFERENCE TO RELATED APPLICATION

This application claims the priority benefit of Taiwan application serial no. 103136133, filed on Oct. 20, 2014. The entirety of the above-mentioned patent application is hereby incorporated by reference herein and made a part of this specification.

### BACKGROUND OF THE INVENTION

1. Field of the Invention

The invention is related to an optical module, and particularly related to an optical module which has high color rendering index.

2. Description of Related Art

With the maturity of photoelectric technology, the lighting emitting mechanism of a light source has developed from thermoluminescence to electroluminescence (EL). Generally speaking, the light source that adopts the EL mechanism has narrower range of emission wavelength. In order to acquire different emission color or broader range of emission wavelength, it is common to utilize a wavelength conversion member (e.g. a phosphor-containing gel) to convert the wavelength of the light emitted by the light source.

For instance, if the light emitted by the light source is, for example, blue light, and the wavelength conversion member is, for example, a yellow phosphor substance, the wavelength conversion member may convert the blue light into yellow light. The yellow light that is generated through excitation and conversion by the wavelength conversion member may be mixed with the blue light that is not converted by the wavelength conversion member so as to generate white light. However, the white light that is obtained through the above mixing method lacks red light wave band, and thus has lower color rendering index.

### SUMMARY OF THE INVENTION

The invention provides an optical module which may provide a light in the form of point light source with high color rendering index.

In the invention, an optical module includes a first light source, a second light source, and a wavelength conversion member. The first light source and the second light source respectively emit light with different colors. The first light source and the second light source respectively have a first light axis and a second light axis, and there is an intersection point of the first light axis and the second light axis. The wavelength conversion member is disposed on the intersection point of the first light axis and the second light axis.

In an embodiment of the invention, a wavelength of the light emitted by the first light source is a first wavelength, and a wavelength of the light emitted by the second light source is a second wavelength. The light emitted by the first light source has a converted wavelength after passing through the wavelength conversion member. The second wavelength is greater than the converted wavelength, and the converted wavelength is greater than the first wavelength.

In an embodiment of the invention, the first light source and the second light source are respectively a laser light source.

In an embodiment of the invention, the optical module further includes a third light source having a third light axis. The first light source, the second light source and the third light source, respectively, emit light with different colors. The first light axis, second light axis and the third light axis intersect at an intersection point, and the wavelength conversion member is disposed on the intersection point of the first light axis, the second light axis and the third light axis.

In an embodiment of the invention, the wavelength of the light emitted by the first light source is a first wavelength; the wavelength of the light emitted by the second light source is a second wavelength; the wavelength of the light emitted by the third light source is a third wavelength. The light emitted by the first light source has a converted wavelength after passing through the wavelength conversion member. The second wavelength and the third wavelength are respectively greater than the converted wavelength, and the converted wavelength is greater than the first wavelength.

In an embodiment of the invention, the first light source, the second light source and the third light source are respectively laser light sources.

In an embodiment of the invention, a light irradiation area of the first light source and the second light source on the intersection point is approximately equivalent with a largest sectional area of the wavelength conversion member.

In the invention, an optical module includes a first light source, a second light source, a third light source and a scattering member. The first light source, second light source and third light source, respectively, emit light with different colors. The first light source, second light source and third light source, respectively, have a first light axis, a second light axis and a third light axis; the first light axis, the second light axis and the third axis have an intersection point. The scattering member is disposed on the intersection point of the first light axis, the second light axis and the third light axis.

In an embodiment of the invention, the first light source, second light source and the third light source are respectively laser light sources.

In an embodiment of the invention, a light irradiation area of the first light source, second light source and third light source on the intersection point is approximately equivalent with a largest sectional area of the scattering member.

Based on the above, in the optical module of the invention, the wavelength conversion member is disposed on the intersection point of the first light axis and the second light axis. The light emitted by the first light source has a converted wavelength after the light passes through the wavelength conversion member, and is mixed with the light emitted by the first light source and the second light source that are not converted so as to generate the light having high color rendering index. Alternatively, in the optical module of the invention, the scattering member is disposed on the intersection point of the first light axis, the second light axis and the third light axis. The light emitted by the first light source, the second light source and the third light source are mixed together when being scattered by the scattering member so as to generate the light having high color rendering index.

In order to make the aforementioned features and advantages of the disclosure more comprehensible, embodiments accompanying figures are described in detail below.

### BRIEF DESCRIPTION OF THE DRAWINGS

FIG. 1 is a schematic view illustrating an optical module according to an embodiment of the invention.

FIG. 2 is a schematic view illustrating an optical module according to another embodiment of the invention.

FIG. 3 is a schematic view illustrating an optical module according to another embodiment of the invention.

### DESCRIPTION OF EMBODIMENTS

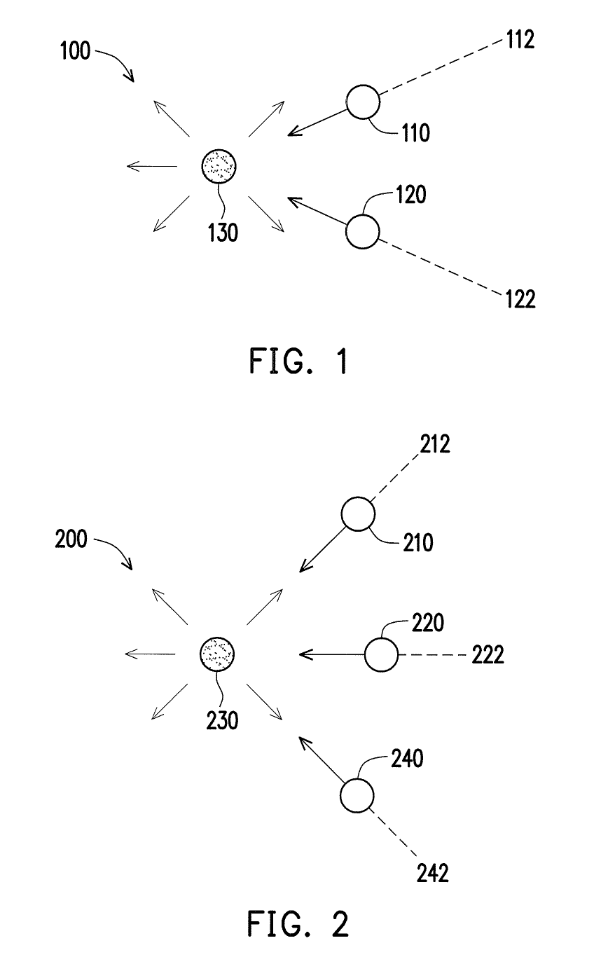

FIG. 1 is a schematic view illustrating an optical module according to an embodiment of the invention. Referring to FIG. 1, an optical module 100 of the embodiment includes a first light source 110, a second light source 120 and a wavelength conversion member 130.

A wavelength of the light emitted by the first light source 110 is a first wavelength; a wavelength of the light emitted by the second light source 120 is a second wavelength. Specifically, the light emitted by the first light source 110 and the light emitted by the second light source 120, respectively, have different colors. In the embodiment, the light emitted by the first light source 110 is blue light, and the light emitted by the second light source 120 is red light; however, the invention provides no limitation to the color of the light emitted by the first light source 110 and the second light source 120.

As shown by FIG. 1, the first light source 110 and the second light source 120, respectively, have a first light axis 112 and a second light axis 122. The light emitted by the first light source 110 and the second light source 120, respectively, are emitted along the first light axis 112 and the second light axis 122, wherein the first light axis 112 and the second light axis 122 have an intersection point. In other words, the first light axis 112 is not parallel with the second light axis 122.

The wavelength conversion member 130 is disposed on the intersection point of the first light axis 112 and the second light axis 122, and the wavelength conversion member 130 converts the wavelength of light. In the embodiment, the light having the first wavelength has a converted wavelength after passing through the wavelength conversion member 130, wherein the converted wavelength is greater than the first wavelength. For example, the first light source 110 is exemplified as a blue light source, and the wavelength conversion member 130 is exemplified as a yellow phosphor substance. After a portion of the light emitted by the first light source 110 passes through the wavelength conversion member 130, the light is converted into yellow light.

In addition, in the embodiment, the second wavelength is greater than the converted wavelength, such that the light emitted by the second light source 120 has the same wavelength after passing through the wavelength conversion member instead of having a converted wavelength. For example, the second light source 120 is exemplified as a red light source, and the light emitted by the second light source 120 still remains as red light after passing through the wavelength conversion member 130.

Therefore, in the embodiment, the wavelength conversion member 130 only converts the light emitted by the first light source 110. Regarding the light emitted by the second light source 120, since the wavelength conversion member 130 is a scattering member, the light emitted by the second light source 120 still has the same wavelength after passing through the wavelength conversion member 130 but is scattered toward different directions.

In the embodiment, since a portion of the light emitted by the first light source 110 is not converted by the wavelength conversion member 130 and has the same wavelength, the yellow light which passes through the wavelength conversion member 130 becomes white light with good color rendering index after being mixed with blue light and red light that are not converted by the wavelength conversion member 130.

In addition, to enable the light which passes through the wavelength conversion member 130 to be emitted in the form of point light source with high luminance, in the embodiment, the first light source 110 and the second light source 120 are respectively laser light sources which have the characteristic of high luminance and high collimation. Certainly, other light sources that have good collimation may also be used as the first light source 110 and the second light source 120; the invention provides no limitation thereto.

In the optical module 100 of the embodiment, the wavelength conversion member 130 is disposed on the intersection point of the first light axis 112 and the second light axis 122. With such configuration, it is sufficient as long as the wavelength conversion member 130 is big enough to cover the intersection area of the first light axis 112 and the second light axis 122. In comparisons with a conventional optical module that has multiple light sources, the light axes of the multiple light sources are disposed in parallel, causing that the size of the wavelength conversion member needs to be larger than or equal to the sum of the light irradiation area of the first light source and the second light source. With the above configuration of the invention, the size of the wavelength conversion member 130 may be effectively reduced. In the embodiment, the largest sectional area of the wavelength conversion member 130 in the optical module 100 is approximately equal to the light irradiation area of the first light source 110 and the second light source 120 at the intersection point. In addition, the wavelength conversion member 130 may be designed with a size which is similar to the size of a single point light source (the first light source 110 or the second light source 120) to be applied to subsequent optical design and has greater design possibilities. Moreover, in the optical module 100 of the embodiment, the light emitted by the first light source 110 has a converted wavelength after passing through the wavelength conversion member 130, and the light is mixed with other light emitted by the first light source 110 that is not converted as well as the light emitted by the second light source 120 so as to generate the light with high color rendering index.

FIG. 2 is a schematic view illustrating an optical module according to another embodiment of the invention. Referring to FIG. 2, the main difference between an optical module 200 in FIG. 2 and the optical module 100 of FIG. 1 lies in that the optical module 200 of FIG. 2 further includes a third light source 240. The wavelength of the light emitted by the third light source 240 is a third wavelength. More specifically, the first light source 210, the second light source 220 and the third light source 240, respectively, emit light with different colors. In the embodiment, the light emitted by the first light source 210 is blue light; the light emitted by the second light source 220 is red light; the light emitted by the third light source 240 is green light. However, the invention provides no limitation to the color of the light emitted by the first light source 210, the second light source 220 and the third light source 240.

Likewise, the third light source 240 has a third light axis 242. As shown by FIG. 2, a first light axis 212, a second light axis 222 and the third light axis 242 intersect at one intersection point. In other words, the first light axis 212, second light axis 222 and the third light axis 242 are not parallel with one another, and the light emitted by the third light source 240 is emitted along the third light axis 242.

The wavelength conversion member 230 is disposed at the intersection point of the first light axis 212, second light axis 222 and the third light axis 242. In the embodiment, the third wavelength is greater than the converted wavelength. Specifically, the third light source 240 is exemplified as a green light source, and the wavelength conversion member 230 is exemplified as a yellow phosphor substance. A portion of the light emitted by the third light source 240 is converted into yellow light after passing through the wavelength conversion member 230.

Therefore, in the embodiment, the wavelength conversion member 230 may convert the light emitted by the first light source 210 and the third light source 240, and the light emitted by the second light source 220 still has the same wavelength after passing through the wavelength conversion member 230. Since a portion of the light emitted by the first light source 210 and the third light source 240 is not converted by the wavelength conversion member 230 and has the same wavelength, the yellow light passing through the wavelength conversion member 230 becomes white light with good color rendering index after being mixed with the blue light, red light and green light that are not converted by the wavelength conversion member 230.

In addition, in the embodiment, the third light source 240 is also a laser light source for providing good collimation and high luminance; however, the third light source 240 may also be other collimate light source; the invention provides no limitation thereto.

In the optical module 200 of the embodiment, the wavelength conversion member 230 is disposed on the intersection point of the first light axis 212, the second light axis 222 and the third light axis 242 so as to effectively reduce the size of the wavelength conversion member 230. Moreover, the light emitted by the first light source 210 and the third light source 240 have a converted wavelength after passing through the wavelength conversion member 230, and mixed with the light emitted by the first light source 210, second light source 220 and third light source 240 that are not converted so as to generate the light with high color rendering index.

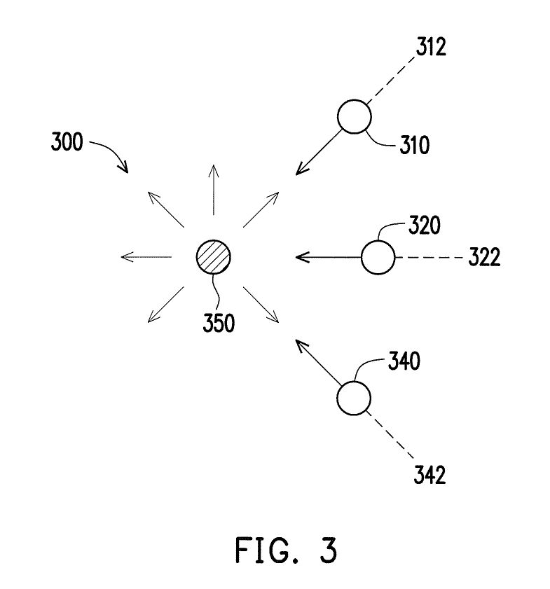

Certainly, the invention provides no limitation to the optical module that emits light with high color rendering index in the form of point light source. FIG. 3 is a schematic view illustrating an optical module according to another embodiment of the invention. Referring to FIG. 3, an optical module 300 of the embodiment includes a first light source 310, a second light source 320, a third light source 340 and a scattering member 350. The first light source 310, second light source 320 and third light source 340, respectively, emit light with different colors. In the embodiment, the first light source 310 is a blue light source, the second light source 320 is a red light source, and the third light source 340 is a green light source. However, the invention provides no limitation to the type of the first light source 310, second light source 320 and third light source 340.

As shown by FIG. 3, the first light source 310, second light source 320 and third light source 340, respectively, have a first light axis 312, a second light axis 322 and a third light axis 342. The light emitted by the first light source 310, second light source 320 and third light source 340 are emitted along the first axis 312, second light axis 322 and third light axis 342, respectively. Moreover, the first light axis 312, second light axis 322 and third light axis 342 have an intersection point. That is to say, the first light axis 312, second light axis 322 and third light axis 342 are not parallel to one another.

The scattering member 350 is disposed on the intersection point of the first light axis 312, second light axis 322 and third light axis 342. The scattering member 350 emits the light emitted by the first light source 310, second light source 320 and third light source 330 toward different directions. In the embodiment, the scattering member 350 may be a white ceramic block having high scattering rate. In other embodiments, the scattering member 350 may be formed by coating a scattering layer in the material of, for example, barium sulfate, barium titanate, barium carbonate, strontium carbonate, lithium carbonate, sodium carbonate, aluminum oxide, titanium oxide, or silicon oxide on a reflective mirror, or may be an element having a surface with micro-structure. Certainly, the above descriptions serve only as an example of the form of scattering member 350; the invention provides no limitation to the form of the scattering member 350.

In the optical module 300 of the embodiment, the scattering member 350 is disposed on the intersection point of the first light axis 312, second light axis 322 and the third light axis 342. With such configuration, it is sufficient as long as the size of the scattering member 350 is big enough to cover the intersection area of the first light axis 312, the second light axis 322 and the third light axis 342, such that the size of the scattering member 350 may be effectively reduced. Therefore, a largest sectional area of the scattering member 350 may be approximately equivalent with the light irradiation area of the first light source 310, second light source 320 and third light source 340 on the intersection point. In addition, the scattering member 350 may be designed with a size which is similar to the size of a single light source (e.g. the first light source 310, the second light source 320, or the third light source 340) so as to reduce the overall size of the optical module 300.

Furthermore, in the embodiment, the first light source 310, second light source 320 and third light source 340 are respectively laser light sources which have the characteristic of high luminance and collimation so that the light scattered by the scattering member 350 can be emitted in the form of point light source with high luminance. Certainly, other light sources that have good collimation may also be used as the first light source 310, second light source 320 and third light source 340; the invention provides no limitation thereto.

In addition, since the first light source 310, second light source 320 and third light source 340, respectively, emit light with different colors, the light emitted by the first light source 310, second light source 320 and third light source 340 are mixed into white light when being scattered by the scattering member 350 so as to generate light with high color rendering index.

In summary, in the optical module of the invention, the wavelength conversion member is disposed on the intersection point of the first light axis and the second light axis. The light emitted by the first light source has a converted wavelength after passing through the wavelength conversion member, and mixed with the light emitted by the first light source and second light source that are not converted so as to generate light with high color rendering index. Alternatively, in the optical module of the invention, the scattering member is disposed on the intersection point of the first light axis, second light axis, and third light axis. The light emitted by the first light source, second light source and third light source are mixed when being scattered by the scattering member so as to generate light with high color rendering index.

Although the invention has been disclosed by the above embodiments, the embodiments are not intended to limit the invention. It will be apparent to those skilled in the art that various modifications and variations can be made to the structure of the invention without departing from the scope or spirit of the invention. Therefore, the protecting range of the invention falls in the appended claims.

What is claimed is:

1. An optical module, comprising:
a first light source having a first light axis;
a second light source having a second light axis, the first light source and the second light source respectively emitting light with different colors, and the first light axis and the second light axis having an intersection point; and
a wavelength conversion member disposed on the intersection point of the first light axis and the second light axis.

2. The optical module according to claim 1, wherein a wavelength of light emitted by the first light source is a first wavelength, a wavelength of light emitted by the second light source is a second wavelength, the light emitted by the first light source has a converted wavelength after passing through the wavelength conversion member, the second wavelength is greater than the converted wavelength, and the converted wavelength is greater than the first wavelength.

3. The optical module according to claim 1, wherein the first light source and the second light source are respectively laser light sources.

4. The optical module according to claim 1, further comprising:
a third light source having a third light axis, the first light source, the second light source and the third light source respectively emitting light with different colors, the first light axis, the second light axis and the third light axis intersecting at the intersection point, and the wavelength conversion member disposed on the intersection point of the first light axis, the second light axis and the third light axis.

5. The optical module according to claim 4, wherein a wavelength of the light emitted by the first light source is a first wavelength, a wavelength of the light emitted by the second light source is a second wavelength, a wavelength of the light emitted by the third light source is a third wavelength, the light emitted by the first light source has a converted wavelength after passing through the wavelength conversion member, the second wavelength and the third wavelength are respectively greater than the converted wavelength, and the converted wavelength is greater than the first wavelength.

6. The optical module according to claim 4, wherein the first light source, the second light source and the third light source are respectively laser light sources.

7. The optical module according to claim 1, wherein a light irradiation area of the first light source and the second light on the intersection point is approximately equivalent with a largest sectional area of the wavelength conversion member.

8. An optical module, comprising:
a first light source having a first light axis;
a second light source having a second light axis;
a third light source having a third light axis, the first light source, the second light source and the third light source respectively emitting light with different colors, and the first light axis, the second light axis and the third light axis having an intersection point; and
a scattering member disposed on the intersection point of the first light axis, the second light axis and the third light axis.

9. The optical module according to claim 8, wherein the first light source, the second light source and the third light source are respectively laser light sources.

10. The optical module according to claim 8, wherein a light irradiation area of the first light source, the second light source and the third light source on the intersection point is approximately equivalent with a largest sectional area of the scattering member.
